(19) United States
(12) Patent Application Publication
(10) Pub. No.: US 2025/0229171 A1
(43) Pub. Date: Jul. 17, 2025

(54) INTERACTION METHOD AND APPARATUS IN VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Qin LI, Shenzhen (CN); Jiani WANG, Shenzhen (CN); Jingchun XU, Shenzhen (CN)

(21) Appl. No.: 19/098,906

(22) Filed: Apr. 2, 2025

Related U.S. Application Data
(63) Continuation of application No. PCT/CN2024/073499, filed on Jan. 22, 2024.

(30) Foreign Application Priority Data
Apr. 7, 2023 (CN) 202310384552.6

(51) Int. Cl. A63F 13/2145; A63F 13/53; A63F 13/837; G06F 3/0486; G06F 3/0488

(52) U.S. Cl. CPC A63F 13/2145; A63F 13/53; A63F 13/837; G06F 3/0486; G06F 3/0488

(57) ABSTRACT

This application provides an interaction method in a virtual scene performed by an electronic device. The method includes: displaying a plurality of interaction objects and at least one interaction control in a virtual scene; controlling, in response to a press operation for a first interaction control, the first interaction control to be in a pressed state; controlling, in response to a selection operation for a first interaction object that is triggered based on the first interaction control in the pressed state, the first interaction object to be in a selected state; and performing, in response to a release operation for the press operation, an interaction operation associated with the first interaction control for the first interaction object.

### CROSS-REFERENCE TO RELATED APPLICATIONS

This application is a continuation application of PCT Patent Application No. PCT/CN2024/073499, entitled “INTERACTION METHOD AND APPARATUS IN VIRTUAL SCENE, ELECTRONIC DEVICE, COMPUTER-READABLE STORAGE MEDIUM, AND COMPUTER PROGRAM PRODUCT” filed on Jan. 22, 2024, which is based upon and claims priority to Chinese Patent Application No. 2023103845526, entitled “INTERACTION METHOD AND APPARATUS IN VIRTUAL SCENE, ELECTRONIC DEVICE, COMPUTER-READABLE STORAGE MEDIUM, AND COMPUTER PROGRAM PRODUCT” filed on Apr. 7, 2023, all of which are incorporated herein by reference in their entirety.

### FIELD OF THE TECHNOLOGY

This application relates to the field of virtualization and human-computer interaction technologies, and in particular, to an interaction method and apparatus in a virtual scene, an electronic device, a computer-readable storage medium, and a computer program product.

### BACKGROUND OF THE DISCLOSURE

A display technology based on graphics processing hardware has expanded channels for environmental perception and information acquisition. Especially, a multimedia technology of a virtual scene can implement, based on an actual application requirement by using a human-computer interaction engine technology, diversified interactions between virtual objects that are controlled by users or artificial intelligence, and has various typical application scenarios, such as a game scene in which an actual interaction process between virtual objects can be simulated.

In the related art, when performing interaction for a specific interaction object of a plurality of interaction objects, it is often necessary to first select the specific interaction object from the plurality of interaction objects through a provided selection control, and then trigger the interaction for the specific interaction object by tapping an interaction control provided for the interaction object. However, this process can be implemented only through a plurality of human-computer interaction operations, resulting in low human-computer interaction efficiency.

### SUMMARY

Embodiments of this application provide an interaction method and apparatus in a virtual scene, an electronic device, a computer-readable storage medium, and a computer program product, which can improve the human-computer interaction efficiency and the utilization of device processing resources, and can improve the utilization of device display resources.

Technical solutions in the embodiments of this application are implemented as follows.

An embodiment of this application provides an interaction method in a virtual scene performed by an electronic device, the method including:
displaying a plurality of interaction objects and at least one interaction control in a virtual scene;
controlling, in response to a press operation for a first interaction control, the first interaction control to be in a pressed state;
controlling, in response to a selection operation for a first interaction object that is triggered based on the first interaction control in the pressed state, the first interaction object to be in a selected state; and
performing, in response to a release operation for the press operation, an interaction operation associated with the first interaction control for the first interaction object.

An embodiment of this application further provides an electronic device, including:
a memory, configured to store computer-executable instructions; and
a processor, configured to implement the interaction method in a virtual scene provided in the embodiments of this application when executing the computer-executable instructions stored in the memory.

An embodiment of this application further provides a non-transitory computer-readable storage medium, having computer-executable instructions stored therein, the computer-executable instructions, when executed by a processor of an electronic device, causing the electronic device to implement an interaction method in a virtual scene provided in the embodiments of this application.

An embodiment of this application further provides a computer program product, including computer-executable instructions or a computer program, the computer-executable instructions or the computer program, when executed by a processor, implementing the interaction method in a virtual scene provided in the embodiments of this application.

The embodiments of this application include the following beneficial effects.

By applying the embodiments of this application, when the press operation for the first interaction control of the at least one interaction control is received, the first interaction control is controlled to be in the pressed state. In this case, the selection operation for the first interaction object of the plurality of interaction objects that is triggered based on the first interaction control may be received in the pressed state, to select the first interaction object. When the press operation is released, the interaction operation associated with the first interaction control is automatically performed for the first interaction object. In this way, the selection function of selecting the first interaction object from the plurality of interaction objects and the function of triggering the interaction operation for the first interaction object are integrated into one interaction control, which not only improves the utilization of device display resources, but also reducing human-computer interaction operations required to achieve interaction objectives, thereby improving the human-computer interaction efficiency and the utilization of device processing resources.

### BRIEF DESCRIPTION OF THE DRAWINGS

FIG. 1A is a schematic diagram of an application mode of an interaction method in a virtual scene according to an embodiment of this application.

FIG. 1B is a schematic diagram of an application mode of an interaction method in a virtual scene according to an embodiment of this application.

FIG. 2 is a schematic diagram of a structure of an electronic device implementing an interaction method in a virtual scene according to an embodiment of this application.

FIG. 3 is a schematic flowchart of an interaction method in a virtual scene according to an embodiment of this application.

FIG. 4 is a schematic display diagram of an interface of a virtual scene according to an embodiment of this application.

FIG. 5 is a schematic flowchart of selecting an interaction object according to an embodiment of this application.

FIG. 6 is a schematic flowchart of selecting an interaction object according to an embodiment of this application.

FIG. 7 is a schematic flowchart of selecting an interaction object according to an embodiment of this application.

FIG. 8 is a schematic flowchart of selecting an interaction object according to an embodiment of this application.

FIG. 9 is a schematic display diagram of a state exit control according to an embodiment of this application.

FIG. 10 is a schematic flowchart of an interaction method in a virtual scene according to an embodiment of this application.

### DESCRIPTION OF EMBODIMENTS

To make objectives, technical solutions, and advantages of this application clearer, the following further describes this application in detail with accompanying drawings. The described embodiments do not be construed as limitation on this application. All other embodiments obtained by a person of ordinary skill in the art based on the embodiments of this application without creative efforts shall fall within the protection scope of this application.

“Some embodiments” involved in the following description describes a subset of all possible embodiments. However, “some embodiments” may be same or different subsets of all the possible embodiments, and may be combined with each other when there is no conflict.

In the following description, the terms “first”, “second”, and “third” are merely intended to distinguish between similar objects and do not indicate a specific sequence of the objects. A specific order or sequence of the “first”, “second”, and “third” may be interchanged if permitted, so that the embodiments of this application described herein may be implemented in a sequence other than the sequence illustrated or described herein.

Unless otherwise defined, meanings of all technical and scientific terms used in this specification are the same as those usually understood by a person skilled in the art. Terms used in the embodiments of this application are merely intended to describe objectives of the embodiments of this application, but are not intended to limit this application.

Before the embodiments of this application are further described in detail, terms involved in the embodiments of this application are described, and the following explanations are applicable to the terms involved in the embodiments of this application.

(1) A client is an application that runs in a terminal and that is configured to provide various services, such as a client supporting a virtual scene (such as a game scene).

(2) “In response to” is configured for representing a condition or a status on which an executed operation depends, and when a dependent condition or status is met, one or more executed operations may be in real time or may have a set delay.

(3) The virtual scene is a virtual scene displayed (or provided) when the application runs on the terminal. The virtual scene may be a simulated environment of the real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene. For example, the virtual scene may include the sky, the land, and the ocean. The land may include environmental elements such as deserts and cities. A user may control a virtual object to perform an action in the virtual scene, and the action includes but is not limited to: any one of adjusting a body posture, crawling, walking, running, riding, jumping, driving, picking up, shooting, attacking, or throwing. The virtual scene may be a virtual scene displayed from a first-person perspective (for example, the user role-plays a virtual object in the game from the user's own perspective), may be a virtual scene displayed from a third-person perspective (for example, the user follows a virtual object in the game to play), or may be a virtual scene displayed from an aerial view. The perspectives may be switched freely.

(4) Scene data represents feature data of the virtual scene. For example, the scene data may be a position of the virtual object in the virtual scene, or may be a position of a virtual building in the virtual scene, or may be a ground area occupied by the virtual building. Certainly, different types of feature data may be included based on types of virtual scenes. For example, in the virtual scene of the game, the scene data may include cooldown time required for various functions configured in the game (which depends on a usage count of the same function within a specific time), and may also represent attribute values of various states of game characters, such as health points (also referred to as red gauge), magic points (also referred to as blue gauge), status points, and hit points.

(5) Virtual objects are images of various people and objects that may perform interaction within the virtual scene, or movable objects in the virtual scene. The movable object may be a virtual character, a virtual animal, an animation character, or the like, such as a person, an animal, a plant, an oil drum, a wall, or a stone displayed in the virtual scene. The virtual object may be a virtual avatar representing the user in the virtual scene. The virtual scene may include a plurality of virtual objects. Each virtual object has a shape and a volume of the virtual object in the virtual scene, and occupies a part of space in the virtual scene.

For example, the virtual object may be a user role controlled through operations on the client, may be artificial intelligence (AI) set in a fight in the virtual scene through training, or may be a non-player character (NPC) set in interaction in the virtual scene. A quantity of virtual objects participating in the interaction in the virtual scene may be preset, or may be dynamically determined based on a quantity of clients participating in the interaction.

(6) An interaction object may be a virtual object (for example, a monster object controlled by a robot program), or may be a virtual object such as a virtual item (for example, a virtual bomb, virtual bow and arrow, or a virtual vehicle) or a virtual resource (for example, virtual coins or a virtual potion).

(7) A virtual item is an item in the virtual scene for the user to perform interaction, and may assist the user in interaction in the virtual scene. For example, the user may control the virtual object to ride the virtual vehicle to move in the virtual scene. For example, the virtual vehicle may be a virtual car, a virtual aircraft, or a virtual yacht. The foregoing scenes are merely used as an example for description herein, and this is not specifically limited in the embodiments of this application. The user may control the virtual object to perform confrontational interaction with another virtual object through the virtual item. For example, the virtual item may be a throwing virtual item such as a virtual grenade, a virtual cluster grenade, or a virtual sticky grenade, or may be a shooting virtual item such as a virtual machine gun, a virtual pistol, or a virtual rifle. A type of the virtual item is not specifically limited in this application.

(8) Virtual resources are various real or fictional objects in the virtual scene that the user (for example, a player) can control the virtual object to collect, such as virtual coins, a virtual potion, virtual plants (for example, flowers, grasses, or mushrooms), virtual fruits (for example, an apples or oranges), and a virtual physical object.

Embodiments of this application provide an interaction method and apparatus in a virtual scene, an electronic device, a computer-readable storage medium, and a computer program product, which can improve the human-computer interaction efficiency and the utilization of device processing resources, and can improve the utilization of device display resources. The descriptions are described below respectively.

When the embodiments of this application are applied to a specific product or technology, relevant data, such as collection, use, and processing of the relevant data need to comply with the laws, regulations, and standards of relevant countries and regions.

For ease of understanding the interaction method in a virtual scene provided in the embodiments of this application, the following describes an exemplary implementation scene of the interaction method in a virtual scene provided in the embodiments of this application. The virtual scene of the interaction method in a virtual scene provided in the embodiments of this application may be completely outputted based on a terminal device, or may be collaboratively outputted based on a terminal device and a server.

In some embodiments, the virtual scene may be an environment for game characters to interact, for example, may be an environment for game characters to fight in the virtual scene. Actions of the virtual objects may be controlled for both parties to interact in the virtual scene, so that the user can obtain gaming experience in the virtual scene during the game.

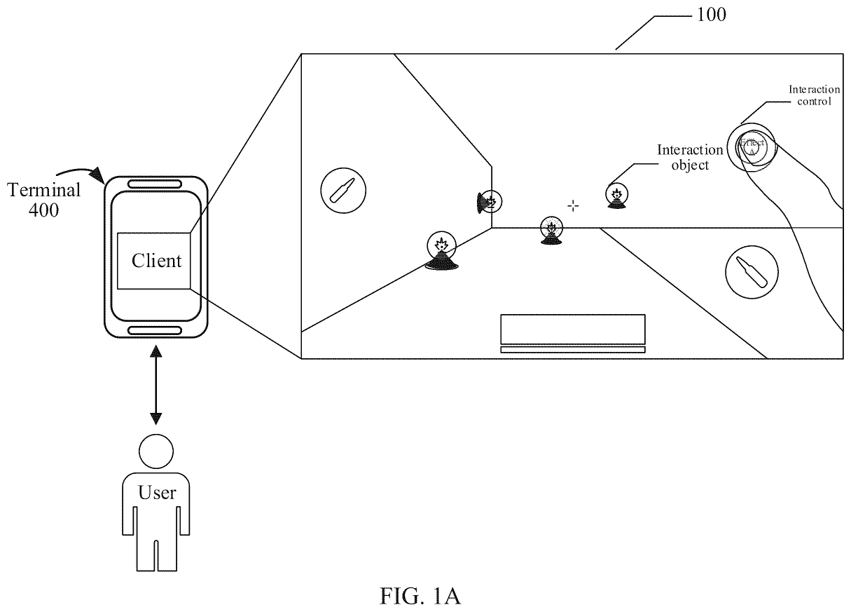

In an implementation scene, FIG. 1A is a schematic diagram of an application mode of an interaction method in a virtual scene. The method is applicable to some application modes in which relevant data computation of a virtual scene 100 can be completed entirely depending on computing power of a terminal 400, such as single-player or offline mode games. The terminal 400 such as a smartphone, a tablet computer, or a virtual reality/augmented reality device is used to complete output of the virtual scene. When forming visual perception of the virtual scene 100, the terminal 400 computes data needed for display by using graphics computing hardware, completes loading, parsing, and rendering of display data, and outputs a video frame that can form the visual perception of the virtual scene by using graphics output hardware, for example, a two-dimensional video frame that is displayed on a display screen of the smartphone, or a video frame for implementing a three-dimensional display effect that is displayed on lenses of augmented reality/virtual reality glasses. In addition, to enrich a perception effect, the device may also use different hardware to form one or more of auditory perception, tactile perception, motion perception, and taste perception.

For example, the terminal 400 runs a client (for example, a single-player game client); outputs the virtual scene based on scene data of the virtual scene during the operation of the client, where the virtual scene is an environment for game characters to interact, such as a plain, a street, or a valley for the game characters to battle; displays a plurality of interaction objects in the virtual scene after the virtual scene is outputted, and displays at least one interaction control, the plurality of interaction objects including a first interaction object, the at least one interaction control including a first interaction control, and each interaction control being associated with an interaction operation for an interaction object; controls, in response to a press operation for the first interaction control, the first interaction control to be in a pressed state; controls, in response to a selection operation for the first interaction object that is triggered based on the first interaction control in the pressed state, the first interaction object to be in a selected state; and performs, in response to a release operation for the press operation, an interaction operation associated with the first interaction control for the first interaction object.

In another implementation scene, FIG. 1B is a schematic diagram of an application mode of an interaction method in a virtual scene. The method is applicable to a terminal 400 and a server 200, and is generally applicable to an application mode in which computation of the virtual scene is completed depending on computing power of the server 200 and the virtual scene is outputted in the terminal 400. The formation of visual perception of a virtual scene 100 is used as an example. The server 200 computes relevant display data of the virtual scene, and sends the display data to the terminal 400. The terminal 400 depends on graphics computing hardware to complete loading, parsing, and rendering of the computed display data, and depends on graphics output hardware to output the virtual scene to form the visual perception, for example, may display a two-dimensional video frame on a display screen of a smartphone, or display a video frame for implementing a three-dimensional display effect on lenses of augmented reality/virtual reality glasses. For perception in a form of the virtual scene, relevant hardware of the terminal may be configured for output, for example, microphone output is used to form auditory perception, and vibrator output is used to form tactile perception.

For example, the terminal 400 runs a client (such as an online game client), obtains scene data of the virtual scene by connecting to a game server (namely, the server 200), and outputs the virtual scene based on the obtained scene data, to perform game interaction with other users in the virtual scene. After outputting the virtual scene, the terminal 400 displays a plurality of interaction objects in a virtual scene, and displays at least one interaction control, the plurality of interaction objects including a first interaction object, the at least one interaction control including a first interaction control, and each interaction control being associated with an interaction operation for an interaction object; controls, in response to a press operation for the first interaction control, the first interaction control to be in a pressed state; controls, in response to a selection operation for the first interaction object that is triggered based on the first interaction control in the pressed state, the first interaction object to be in a selected state; and performs, in response to a release operation for the press operation, an interaction operation associated with the first interaction control for the first interaction object.

In some embodiments, the terminal 400 or the server 200 may implement the interaction method in a virtual scene provided in the embodiments of this application by running a computer program. For example, the computer program may be an original program or a software module in an operating system, or may be a native application (APP), that is, a program (for example, a game client) that needs to be installed in an operating system to run, or may be a mini program, that is, a program that only needs to be downloaded to a browser environment to run, or may be a mini program (for example, a game mini program) that can be embedded in any APP. In conclusion, the computer program may be any form of an application, a module, or a plug-in.

The embodiments of this application may be implemented by using a cloud technology. The cloud technology is a hosting technology that unifies a series of resources such as hardware, software, and a network in a wide area network or a local area network, to implement data computing, storage, processing, and sharing. Cloud technology is a general term for a network technology, an information technology, an integration technology, a management platform technology, an application technology, and the like that are applied based on a cloud computing business model. The technologies can form a resource pool to be flexibly used on demand. A cloud computing technology is becoming an important support. A background service of a technical network system needs a large quantity of computing and storage resources.

For example, the server (such as the server 200) may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal (such as the terminal 400) may be a smartphone, a tablet computer, a laptop computer, a desktop computer, an intelligent voice interaction device (such as a smart speaker), a smart appliance (such as a smart television), a smart watch, and a vehicle terminal, a wearable device, a virtual reality (VR) device, or the like, but this is not limited thereto. The terminal and the server may be connected directly or indirectly in a wired or wireless communication protocol. This is not limited in embodiments of this application.

In some embodiments, a plurality of servers may form a blockchain, and the server is a node on the blockchain. Information connection may exist between nodes of the blockchain, and information transmission may be performed between the nodes through the information connection. Data (such as the scene data of the virtual scene) related to the interaction method in a virtual scene provided in the embodiments of this application may be stored in the blockchain.

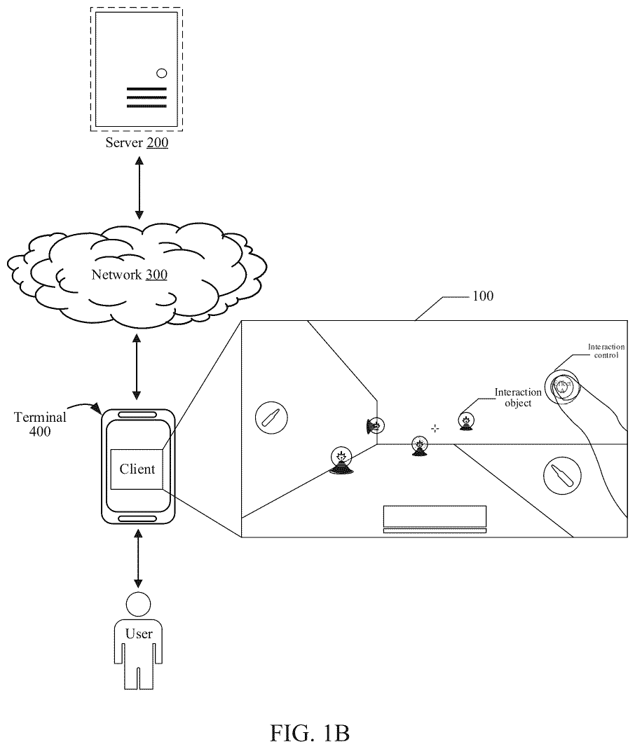

The following describes an electronic device that implements an interaction method in a virtual scene provided in the embodiments of this application. FIG. 2 is a schematic diagram of a structure of an electronic device 500 implementing an interaction method in a virtual scene according to an embodiment of this application. The electronic device 500 provided in the embodiments of this application may be a terminal, or may be a server. The electronic device 500 provided in the embodiments of this application includes at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 further includes a power bus, a control bus, and a status signal bus. However, for ease of clear description, all types of buses are marked as the bus system 540 in FIG. 2.

In some embodiments, the interaction apparatus in a virtual scene provided in the embodiments of this application may be implemented by using software. FIG. 2 shows an interaction apparatus 555 in a virtual scene that is stored in the memory 550. The interaction apparatus may be software in a form of a program, a plug-in, or the like, including the following software modules: a display module 5551, a first control module 5552, a second control module 5553, and a third control module 5554. These modules are logical, so that the modules may be combined or further split based on functions implemented. The functions of the modules are explained in the following.

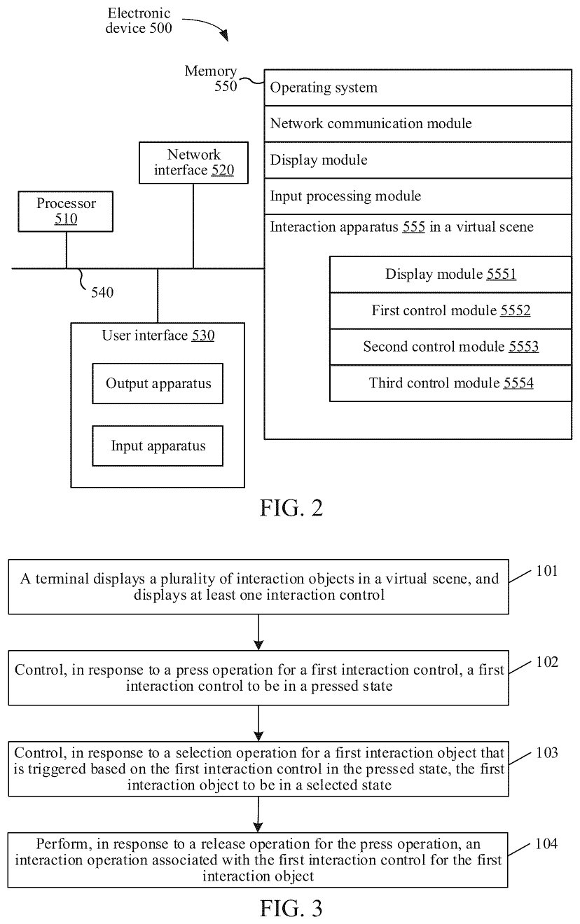

The following describes the interaction method in a virtual scene provided in the embodiments of this application. In some embodiments, the interaction method in a virtual scene provided in the embodiments of this application may be implemented by various electronic devices, for example, may be implemented by a terminal alone, or may be implemented by a server alone, or may be implemented by the terminal and the server collaboratively. The terminal is used as an example for implementation. FIG. 3 is a schematic flowchart of an interaction method in a virtual scene according to an embodiment of this application. The interaction method in a virtual scene provided in the embodiments of this application includes the following operations:

Operation 101: A terminal displays a plurality of interaction objects in a virtual scene, and displays at least one interaction control,
the plurality of interaction objects including a first interaction object, the at least one interaction control including a first interaction control, and each interaction control being associated with an interaction operation for an interaction object.

In operation 101, the terminal may run a client (for example, a game client) supporting the virtual scene, and the terminal outputs the virtual scene during operation of the client. For example, the terminal may obtain scene data of the virtual scene from a server, and then render the scene data, to output the virtual scene (for example, a game scene). Herein, the virtual scene may include a target virtual object, and the target virtual object may be a virtual character controlled by a user entering the virtual scene. Certainly, the virtual scene may further include another virtual object, and the another virtual object may be controlled by another user or controlled by a robot program.

In the embodiments of this application, the virtual scene further includes an interaction object. The interaction object may be a virtual object (for example, a monster object controlled by the robot program or a virtual object of another player participating in the virtual scene), or may be a virtual object such as a virtual item (for example, a virtual bomb, virtual bow and arrow, or a virtual vehicle) or a virtual resource (for example, a virtual coins or a virtual potion). The user may control the target virtual object to interact with an interaction object in the virtual scene, such as, attacking an interaction object (for example, the monster object controlled by the robot program), socializing (for example, handshaking, greeting, or talking) with an interaction object, collecting an interaction object (for example, the virtual coins), using an interaction object (for example, the virtual bomb), activating an interaction object (for example, a virtual object supporting a virtual skill (for example, attacking or replenishing health points)), pick up an interaction object (for example, the virtual arrow), or recycle an interaction object (for example, the virtual potion).

In the embodiments of this application, an interaction control configured to trigger to perform an interaction operation for the interaction object is further provided. In actual application, the interaction control may be displayed in an interface of the virtual scene. For example, the interaction control is displayed in a preset region in the interface of the virtual scene. A quantity of interaction controls may be one or more, and may be specifically determined based on a quantity of interaction operations performable for the plurality of interaction objects. For example, if there are five interaction objects in the virtual scene, and there are three interaction operations performable for the five interaction objects, there are also three interaction controls. Each interaction control is associated with an interaction operation for an interaction object. The interaction operation includes, but is not limited to, an attack operation, a collection operation, an activation operation, a use operation, a recycle operation, a pick-up operation, or the like.

In some embodiments, the terminal may display the at least one interaction control in the following manner: determining at least one target interaction operation performable for the plurality of interaction objects; and displaying an interaction control of the at least one target interaction operation, the interaction control and the target interaction operation being in a one-to-one correspondence. Herein, the quantity of the interaction controls is determined based on the quantity of interaction operations performable for the plurality of interaction objects. That is, a quantity of target interaction operations performable for the plurality of interaction objects is equal to the quantity of the interaction controls, which means that the interaction control and the target interaction operation are in a one-to-one correspondence. This avoids displaying the corresponding interaction control for each interaction object, thereby reducing the obstruction of the interaction control in the virtual scene, and improving the utilization of device display resources and the experience of the user in participating in the virtual scene.

In some embodiments, when displaying the plurality of interaction objects in the virtual scene, the terminal may further display, for each interaction object, interaction indication information of the interaction object, the interaction indication information being configured for indicating an interaction operation performable for the interaction object. Herein, the interaction indication information may be displayed independent of the interaction object, or may be displayed dependent on the interaction object. For example, the interaction indication information is displayed in an associated region of the interaction object (for example, an upper region of the interaction object), and interaction indication information corresponding to different interaction operations is displayed in different information display manners (for example, display colors of the interaction indication information corresponding to the different interaction operations are different, and display fonts of the interaction indication information corresponding to the different interaction operations are different). This can provide to the user with an operation prompt, thereby improving the operation experience of the user in the virtual scene.

In some embodiments, the interaction indication information may further be displayed when a display condition is satisfied. For example, when the user triggers a display instruction for the interaction indication information (for example, triggered based on a provided indication information display control), it is determined that the display condition is satisfied. For another example, when the interaction object is displayed in the interface, it is determined that the display condition of the interaction indication information of the interaction object is satisfied. In some embodiments, the displayed interaction indication information may further be canceled from being displayed when a display cancel condition is satisfied. For example, when a display duration of the interaction indication information reaches a display duration threshold, it is determined that the display cancel condition is satisfied. This can enable or disable the display of the interaction indication information based on needs, and adaptively reduce the obstruction of information in the virtual scene, thereby improving the utilization of device display resources and the experience of the user in the virtual scene.

In some embodiments, the terminal may display the at least one interaction control in the following manner: performing the following processing for each interaction control: displaying the interaction control in an activated state by using a first control style when an activation condition of the interaction control is satisfied; or displaying the interaction control in an inactivated state by using a second control style when an activation condition of the interaction control is not satisfied. Herein, each interaction control may be further set with a corresponding activation condition. When the activation condition of the interaction control is satisfied, the interaction control is activated, and the interaction control in the activated state is displayed by using the first control style. When the activation condition of the interaction control is not satisfied, the interaction control in the inactivated state is displayed by using the second control style. The activated state is configured for indicating that an interaction operation of the target virtual object for the interaction object can be triggered through the interaction control. The first control style is different from the second control style. For example, the interaction control in the activated state may be displayed in a highlighted control style, and the interaction control in the inactivated state may be displayed by using a preset grayscale control style. In actual application, the activation condition may be preset. For example, whether an object state (such as hit points, health points, or an attack value) of the target virtual object satisfies a state condition, whether an activation count of the interaction object reaches an activation count threshold, or whether the interaction object is in an interactive state. This enables distinctive display of interaction controls in different states, thereby improving the operation experience of the user in the virtual scene. Since the interaction control can be activated only when the activation condition is satisfied, it can also simulate the enthusiasm of the user to interact in the virtual scene, thereby improving user stickiness in the virtual scene.

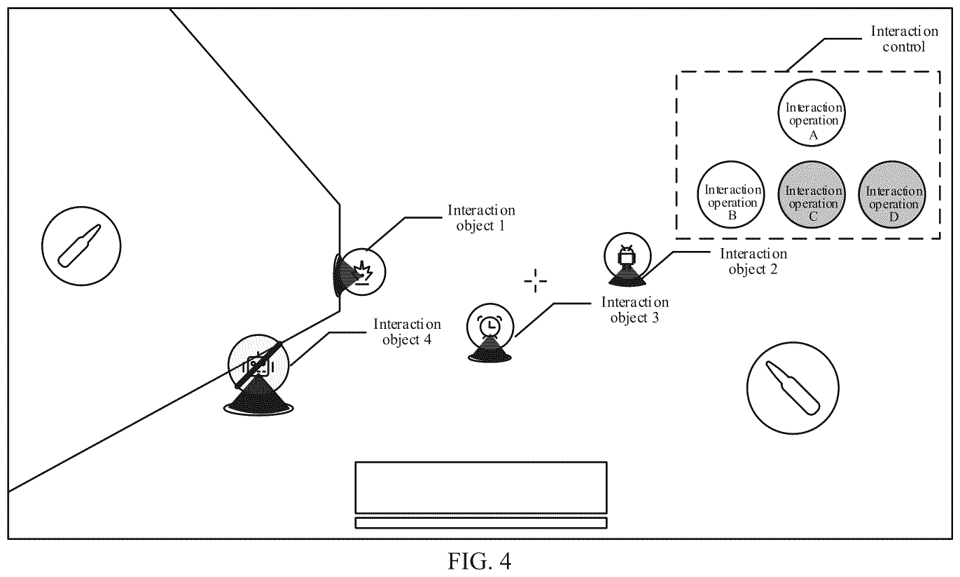

For example, FIG. 4 is a schematic display diagram of an interface of a virtual scene according to an embodiment of this application. Herein, four interaction objects and four interaction controls are displayed in the interface of the virtual scene. An interaction control A and an interaction control B are in an activated state, and an interaction control C and an interaction control D are in an inactivated state. An interaction object 1 to an interaction object 3 are in an interactive state, and an interaction object 4 is in a non-interactive state. In this case, only corresponding interaction operations can be performed on the interaction object 1 to the interaction object 3 through the interaction controls.

Operation 102: Control, in response to a press operation for the first interaction control, the first interaction control to be in a pressed state.

In operation 102, the press operation for the first interaction control may be triggered to control the first interaction control to be in the pressed state. A display style of the interaction control in the pressed state may be different from a display style of the interaction control not in the pressed state. In some embodiments, the terminal may trigger the press operation for the first interaction control in at least one of the following manners: a press duration for the first interaction control reaching a press duration threshold; a press intensity for the first interaction control reaching a press intensity threshold; and a press area for the first interaction control reaching a press area threshold. This enables the user to trigger the press operation in different manners, thereby enhancing the diversity of human-computer interaction in the virtual scene, improving the attractiveness of the virtual scene to the user, and increasing the user stickiness.

In some embodiments, the terminal may display the plurality of interaction objects in the virtual scene in the following manner: displaying the plurality of interaction objects under a first perspective in the virtual scene. Correspondingly, after controlling the first interaction control to be in the pressed state, the terminal further controls the first perspective to be in a locked state, and receives, in the locked state, a selection operation for the first interaction object that is triggered by the first interaction control in the pressed state. Herein, the terminal displays the plurality of interaction objects observed from the first perspective. After controlling the first interaction control to be in the pressed state, the terminal further controls the first perspective to be in the locked state. In this case, when the user operates on a human-computer interaction interface of the terminal, the first perspective no longer changes. This is convenient for the user to select the interaction object, and improves the human-computer interaction efficiency and the utilization of device processing resources.

In some embodiments, after controlling the first interaction control to be in the pressed state, the terminal may receive the selection operation for the first interaction object in the following manners: receiving a drag operation performed from a press action position of the press operation; and receiving, when a drag end position of the drag operation is configured for indicating to select the first interaction object, the selection operation for the first interaction object that is triggered based on the first interaction control in the pressed state. Herein, while maintaining the press operation, the user may perform the drag operation from the press action position of the press operation, to select the first interaction object from the plurality of interaction objects. The terminal receives the drag operation performed from the press action position of the press operation; and receives, when the drag end position of the drag operation is configured for indicating to select the first interaction object, the selection operation for the first interaction object that is triggered based on the first interaction control in the pressed state. This enables the selection of the interaction object by triggering the press operation and continuing to perform the drag operation based on the press operation. The operation is smooth and simple, allowing for single-handed implementation by the user, thereby simplifying the selection operation of the interaction object, and improving the human-computer interaction efficiency and the experience of the user in the virtual scene.

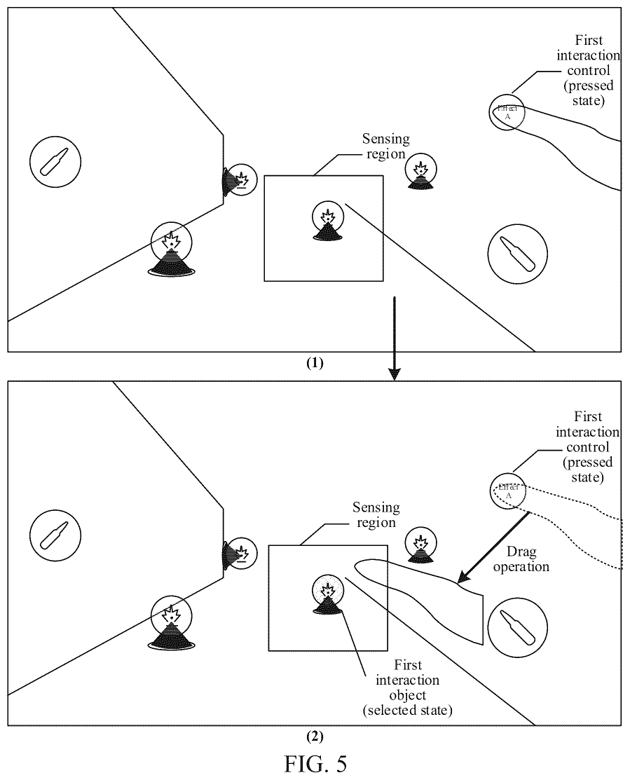

In some embodiments, the terminal may determine, in the following manner, that the drag end position is configured for indicating to select the first interaction object: determining, when the drag end position is in a sensing region of the first interaction object, that the drag end position is configured for indicating to select the first interaction object. Herein, the sensing region of the first interaction object may be a region of a target shape by using the first interaction object as a center, such as a circular region or a square region. For example, FIG. 5 is a schematic flowchart of selecting an interaction object according to an embodiment of this application. Herein, in response to the press operation for the first interaction control, the first interaction control is controlled to be in the pressed state, as shown in (1) in FIG. 5. When the first interaction control is in the pressed state, the drag operation performed from the press action position of the press operation is received; and when the drag end position of the drag operation is in the sensing region of the first interaction object, it is determined that the drag end position is configured for indicating that the selected interaction object is the first interaction object. In this case, the first interaction object is controlled to be in a selected state, as shown in (2) in FIG. 5. This enables the selection of the first interaction object by performing the drag operation to the sensing region of the first interaction object while in the pressed state. The operation is smooth and simple, allowing for single-handed implementation by the user, thereby simplifying the selection operation of the interaction object, and improving the human-computer interaction efficiency and the utilization of device processing resources.

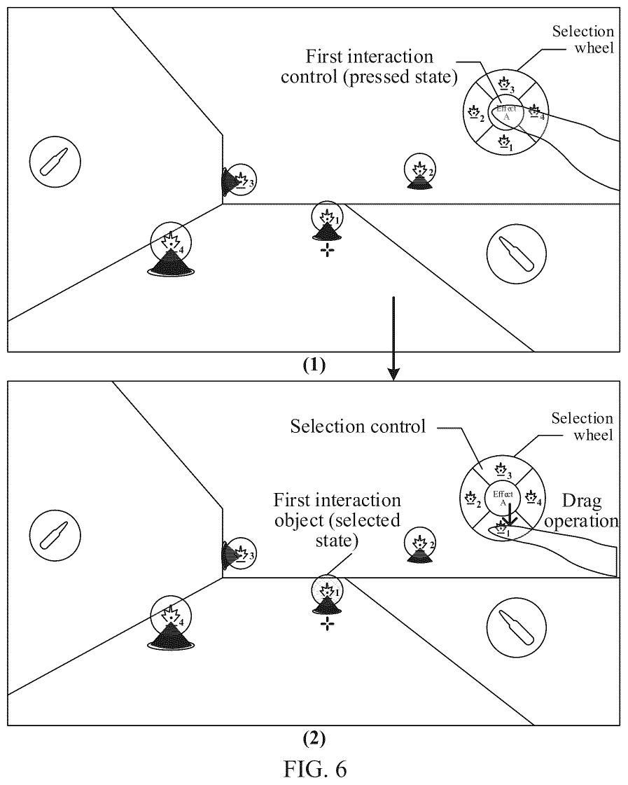

In some embodiments, the terminal may determine, in the following manner, that the drag end position is configured for indicating to select the first interaction object: determining, when the drag end position is in a region at which a selection control of the first interaction object is located, that the drag end position is configured for indicating to select the first interaction object. Herein, a corresponding selection control may be set for each first interaction object. For example, FIG. 6 is a schematic flowchart of selecting an interaction object according to an embodiment of this application. Herein, in response to the press operation for the first interaction control, the first interaction control is controlled to be in the pressed state, as shown in (1) in FIG. 6. When the first interaction control is in the pressed state, the drag operation performed from the press action position of the press operation is received; and when the drag end position of the drag operation is in the region at which the selection control of the first interaction object is located, it is determined that the drag end position is configured for indicating to select the first interaction object. In this case, the first interaction object is controlled to be in the selected state, as shown in (2) in FIG. 6.

In some embodiments, the terminal may display a selection wheel, the selection wheel being configured to display a selection control of each interaction object in a wheel form around the first interaction control. Correspondingly, the terminal may receive, in the following manner, the drag operation performed from the press action position of the press operation: receiving the drag operation performed on the selection control of the first interaction object in the selection wheel from the press action position of the press operation; and correspondingly, determining, when the drag end position is in the selection control of the first interaction object in the selection wheel, that the drag end position is configured for indicating to select the first interaction object. Herein, still referring to FIG. 6, the selection control of each interaction object is displayed in the wheel form around the first interaction control, to form one selection wheel. When the drag operation is performed, the drag operation may be performed on the selection control of the first interaction object in the selection wheel from the press action position of the press operation, so that when the drag end position is in the selection control of the first interaction object in the selection wheel, it is determined that the drag end position is configured for indicating to select the first interaction object. In this case, the first interaction object is controlled to be in the selected state. This enables the selection of the first interaction object by performing the drag operation to the selection control of the first interaction object while in the pressed state. The operation is smooth and simple. In addition, since the selection control is in the selection wheel, a drag displacement of the drag operation is reduced, thereby further simplifying the selection operation of the interaction object, and improving the human-computer interaction efficiency and the utilization of device processing resources.

In some embodiments, the terminal may display an operation region of the drag operation. Correspondingly, the terminal may receive, in the following manner, the drag operation performed from the press action position of the press operation: receiving, within the operation region, the drag operation performed from the press action position of the press operation. Correspondingly, the terminal may determine, in the following manner, that the drag end position is configured for indicating that the selected interaction object is the first interaction object: determine, when the drag end position is a target position within the operation region, that the drag end position is configured for indicating to select the first interaction object, the target position corresponding to a position of the first interaction object. Herein, the drag operation may be provided with one operation region. The user may perform the drag operation within the operation region. The operation region may be centered around the first interaction control. When the first interaction control is in the pressed state, the drag operation performed from the press action position of the press operation may be received within the operation region. Each position within the operation region corresponds to a specific position in the virtual scene. In this way, when the target position corresponds to the position of the first interaction object, if the drag end position is the target position within the operation region, it is determined that the drag end position is configured for indicating to select the first interaction object. This enables the selection of the first interaction object by performing the drag operation to the target position within the operation region that is configured for indicating the first interaction object while in the pressed state. The operation is smooth and simple. In addition, since a range of the drag operation is a preset operation region, the drag displacement of the drag operation can be reduced, thereby simplifying the selection operation of the interaction object, and improving the human-computer interaction efficiency and the utilization of device processing resources.

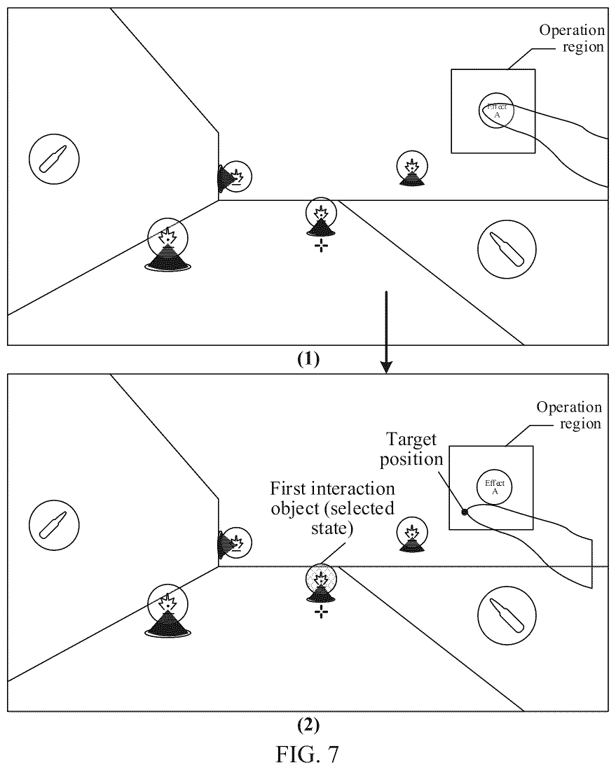

For example, FIG. 7 is a schematic flowchart of selecting an interaction object according to an embodiment of this application. Herein, in response to the press operation for the first interaction control, the first interaction control is controlled to be in the pressed state, as shown in (1) in FIG. 7. In addition, the operation region for the drag operation is set centered around the first interaction control. When the first interaction control is in the pressed state, the drag operation performed from the press action position of the press operation within the operation region is received; and when the drag end position of the drag operation is the target position, it is determined that the drag end position is configured for indicating that the selected interaction object is the first interaction object. In this case, the first interaction object is controlled to be in the selected state, as shown in (2) in FIG. 7.

In some embodiments, the terminal may display a crosshair pattern corresponding to the drag operation, and a crosshair position of the crosshair pattern is a position indicated by an action point of the drag operation in the virtual scene. Correspondingly, the terminal may determine, in the following manner, that the drag end position is configured for indicating that the selected interaction object is the first interaction object: determining, when the drag operation ends and the crosshair position of the crosshair pattern is located at the sensing region of the first interaction object, that the drag end position is configured for indicating to select the first interaction object. Herein, to make it convenient for the user to select the interaction object through the drag operation, the crosshair pattern corresponding to the drag operation may further be displayed. The crosshair position of the crosshair pattern is a position indicated by the action point of the drag operation in the virtual scene. In this way, when the drag operation ends and the crosshair position of the crosshair pattern is located at the sensing region of the first interaction object, it is determined that the drag end position is configured for indicating that the selected interaction object is the first interaction object. This enables the selection of the interaction object by performing the drag operation to adjust the crosshair position while in the pressed state. The operation is smooth and simple. In addition, the crosshair pattern allows for quicker aiming of an interaction object to be selected, to enable quick selection of the interaction object, thereby further simplifying the human-computer interaction operation, and improving the human-computer interaction efficiency and the utilization of device processing resources.

In some embodiments, the target virtual object has a virtual aiming item, and the terminal may display a crosshair pattern of the virtual aiming item. Correspondingly, after controlling the first interaction control to be in the pressed state, the terminal may receive the selection operation for the first interaction object in the following manner: determining a first distance between a position of each interaction object and the crosshair position of the crosshair pattern; and receiving, when an interaction object corresponding to a smallest first distance is the first interaction object, the selection operation for the first interaction object that is triggered based on the first interaction control in the pressed state.

Herein, the target virtual object may have a virtual aiming item with an aiming function, such as a virtual shooting item. In this case, the terminal displays the crosshair pattern of the virtual aiming item in the interface of the virtual scene. However, when the user triggers the press operation for the first interaction control, one interaction object may be automatically selected by using the crosshair pattern, thereby reducing the human-computer interaction operation of the user, and improving the human-computer interaction efficiency and the utilization of device processing resources. Specifically, after the first interaction control is controlled to be in the pressed state, the first distance between the position of each interaction object and the crosshair position of the crosshair pattern is determined. Therefore, the interaction object corresponding to the smallest first distance is used as an automatically selected first interaction object.

In some embodiments, the terminal may switch, in the following manner, from selecting the first interaction object to selecting a second interaction object: receiving a move operation for the crosshair pattern in the pressed state; determining a second distance between the position of each interaction object and the crosshair position of the crosshair pattern when a movement distance of the crosshair pattern reaches a distance threshold; controlling the first interaction object to exit the selected state, and controlling the second interaction object corresponding to a smallest second distance to be in the selected state, the plurality of interaction objects including the second interaction object.

Herein, after one interaction object is selected by default, the user may further switch the selected interaction object by adjusting the position of the crosshair pattern. Specifically, the move operation for the crosshair pattern is received in the pressed state; and the second distance between the position of each interaction object and the crosshair position of the crosshair pattern is determined when the movement distance of the crosshair pattern reaches the distance threshold. Therefore, the first interaction object is controlled to exit the selected state, and the second interaction object corresponding to the smallest second distance is controlled to be in the selected state.

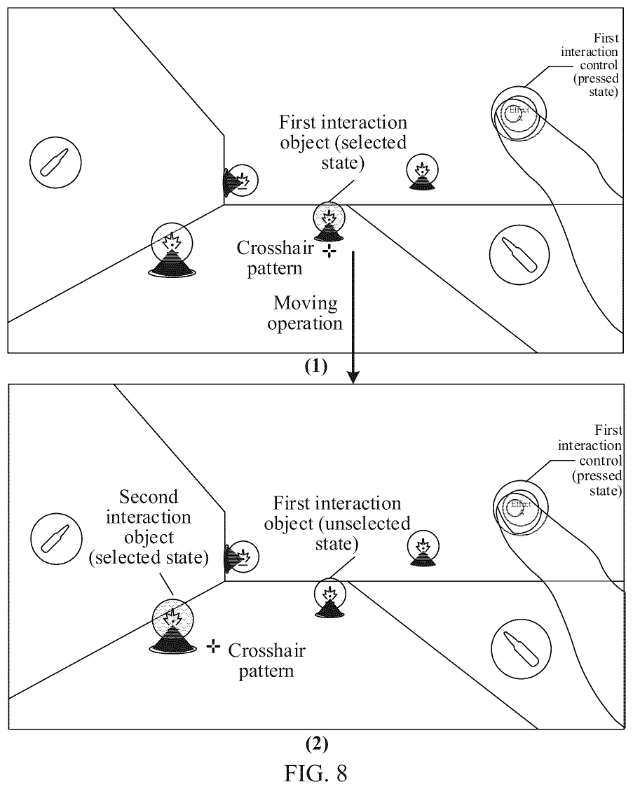

For example, FIG. 8 is a schematic flowchart of selecting an interaction object according to an embodiment of this application. Herein, in response to the press operation for the first interaction control, the first interaction control is controlled to be in the pressed state, as shown in (1) in FIG. 8. In addition, the crosshair pattern of the virtual aiming item is displayed in the interface of the virtual scene. In this case, the first interaction object closest to the crosshair pattern is selected by default through the press operation, that is, the first interaction object is controlled to be in the selected state, and the move operation for the crosshair pattern is received. In this case, the selected interaction object is switched from the first interaction object to the second interaction object closest to the crosshair pattern after the movement, that is, the first interaction object is controlled to exit the selected state, and the second interaction object is controlled to be in the selected state, as shown in (2) in FIG. 8.

Operation 103: Control, in response to the selection operation for the first interaction object that is triggered based on the first interaction control in the pressed state, the first interaction object to be in the selected state.

In operation 103, when the selection operation for the first interaction object that is triggered based on the first interaction control in the pressed state is received, the first interaction object is controlled to be in the selected state in response to the selection operation for the first interaction object. A display style of the interaction object in the selected state is different from a display style of an interaction object in an unselected state. This enables effective distinction of the selected interaction object.

In some embodiments, after controlling the first interaction object to be in the selected state, the terminal may display the first interaction object by using a first object style; and display other interaction objects of the plurality of interaction objects except the first interaction object by using a second object style, the second object style being different from the first object style. Herein, the first object style may be a highlighted display style, and the second object style may be a preset grayscale display style, as shown in FIG. 8. Certainly, the display style may also be another display style. This is not limited herein.

Operation 104: Perform, in response to a release operation for the press operation, an interaction operation associated with the first interaction control for the first interaction object.

In operation 104, the user may release the press operation to trigger the interaction operation for the first interaction object. The terminal performs, in response to the release operation for the press operation, the interaction operation associated with the first interaction control for the first interaction object. The virtual scene includes the target virtual object corresponding to the user. Therefore, the target virtual object may be controlled to perform the interaction operation associated with the first interaction control for the first interaction object. In this way, the interaction operation for the first interaction object can be automatically triggered by releasing the press operation, thereby simplifying the control process of the interaction operation, and further improving the human-computer interaction efficiency and the utilization of device resources. In addition, it further improves the operation experience of the user in selecting the interaction object and performing interaction in the virtual scene, and increases the stickiness of the virtual scene.

In some embodiments, the terminal may exit the pressed state in the following manner: displaying a state exit control of the pressed state; when receiving a trigger operation for the state exit control, controlling the first interaction control to exit the pressed state; and when there is a second interaction object in the selected state, controlling the target virtual object to skip performing the interaction operation associated with the first interaction control for the second interaction object.

Herein, the state exit control may further be provided, for the user to control, based on the state exit control, the first interaction control to exit the pressed state. The exiting the pressed state herein actually means that the terminal terminates the current selection operation of the interaction object and the interaction operation with the interaction object. Therefore, when the trigger operation for the state exit control is received, if there is the second interaction object in the selected state, the target virtual object is controlled to skip performing the interaction operation associated with the first interaction control for the first interaction object for the second interaction object.

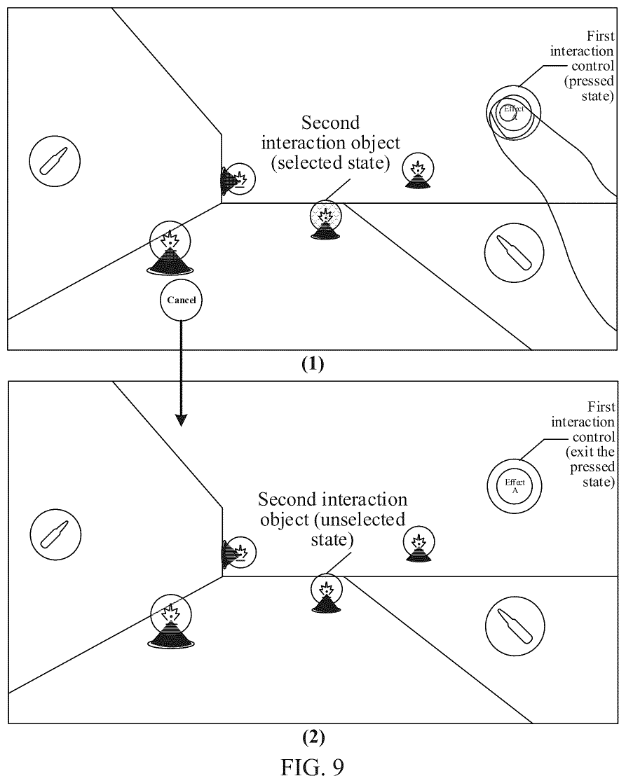

For example, FIG. 9 is a schematic display diagram of a state exit control according to an embodiment of this application. Herein, when the first interaction control is in the pressed state, a state cancel control “cancel” is displayed. In addition, in this case, the second interaction object is in the selected state, as shown in (1) in FIG. 9. In response to a trigger operation for the state cancel control “cancel”, the first interaction control is controlled to exit the pressed state, and the target virtual object is controlled to skip performing the interaction operation associated with the first interaction control for the second interaction object, that is, the second interaction object is controlled to be in the unselected state, as shown in (2) in FIG. 9.

By applying the embodiments of this application, when the press operation for the first interaction control of the at least one interaction control is received, the first interaction control is controlled to be in the pressed state. In this case, the selection operation for the first interaction object of the plurality of interaction objects that is triggered based on the first interaction control may be received in the pressed state, to select the first interaction object. When the press operation is released, the interaction operation associated with the first interaction control is automatically performed for the first interaction object. In this way, the selection function of selecting the first interaction object from the plurality of interaction objects and the function of triggering the interaction operation for the first interaction object are integrated into one interaction control, which not only improves the utilization of device display resources, but also reducing human-computer interaction operations required to achieve interaction objectives, thereby improving the human-computer interaction efficiency and the utilization of device processing resources.

That the virtual scene is the game scene is used as an example below to describe an exemplary application in an actual application scenario in the embodiments of this application.

In some embodiments of this application, selection and interaction of the interaction object may be implemented in the following interaction manners: (1) Distance-restricted type The player needs to control the virtual object to approach to an interaction object to be selected. In this case, the human-computer interaction interface displays a corresponding interaction control, and the player may tap the interaction control to perform interaction. However, this interaction manner is not applicable to a large range of situations where there are a plurality of candidate interaction objects simultaneously. (2) Swipe selection type The player swipes to aim and select the interaction object. In this case, the human-computer interaction interface displays the corresponding interaction control, and the player may tap the interaction control to perform interaction. However, this interaction manner requires step-by-step aiming and selection, resulting in a cumbersome operation. (3) Direct selection type The player may directly tap, by using fingers, a displayed interaction button on the interaction object in the game scene to perform interaction. Although this manner reduces the operation of selecting the interaction object, (a) the interaction control is not necessarily in an operating hot zone; (b) the interaction control moves with the player, making it difficult to tap; and (c) each interaction object displays a corresponding interaction control, causing excessive obstruction on the virtual scene.

Based on this, the embodiments of this application further provide an interaction method in a virtual scene, to resolve at least the foregoing existing problems. In the embodiments of this application, a selection function for the interaction object and a function of triggering the interaction operation for the selected interaction object are integrated on one interaction control. In this way, the player can quickly select the first interaction object from the plurality of interaction objects through one interaction control, for example, by pressing and dragging the interaction control by using one finger, and perform a corresponding interaction operation for the first interaction object after releasing the press. Therefore, a window period time of the selection operation of the interaction object is reduced, thereby simplifying the operations of the player, and improving the operation efficiency.

The interaction method in a virtual scene provided in the embodiments of this application is described in detail.

(1) When there are a plurality of interaction objects of one type in the game scene, and there is only one interaction operation performable for the plurality of interaction objects:

As shown in FIG. 4, in an initial state, the player may clearly observe an interactive interaction object UI and an interaction control at a preset position in the game scene.

As shown in FIG. 9, when the player intends to implement an interaction operation A on an interaction object, the player needs to select the interaction object. In this case, the player may trigger a press operation for the interaction control, to control the interaction control to enter the pressed state. Certainly, a press cancel control “cancel” may also be displayed in the pressed state, and the interaction control may be controlled to exit the pressed state through the press cancel control.

In the pressed state, if the game scene includes a crosshair with an aiming function, (a) as shown in (1) in FIG. 8, the system may select an interactive interaction object closest to the crosshair by default. In this case, a UI state of the interaction object is switched from the unselected state to the selected state, so that the player may trigger the interaction operation for the interaction object by releasing the press operation; and (b) as shown in (2) in FIG. 8, if the player needs to select another object, the player may change the selected interaction object by dragging a pressed finger in the pressed state. For example, as shown in (2) in FIG. 8, a default selected interaction object is changed from “first interaction object” to “second interaction object”. In addition, the UI selected state of the interaction object is changed.

As shown in FIG. 6, when the interaction control is pressed to select the interaction object, if there are only a plurality of interaction objects having the same interaction operation in the game scene, the plurality of interaction objects may be numbered and selected in a wheel manner, so that when the player releases the press operation, the interaction operation for the selected interaction object is triggered.

(2) When there are a plurality of interaction objects of a plurality of types in the game scene, different object display styles (such as object icons) may be used to distinguish the interaction objects of different types, as shown in FIG. 4. When there are a plurality of interaction objects in the game scene, and a plurality of interaction operations are applicable simultaneously, an interaction control corresponding to the interaction operation may be newly added to a preset region in the screen. The interaction manner in (1) is also applicable, as shown in FIG. 4.

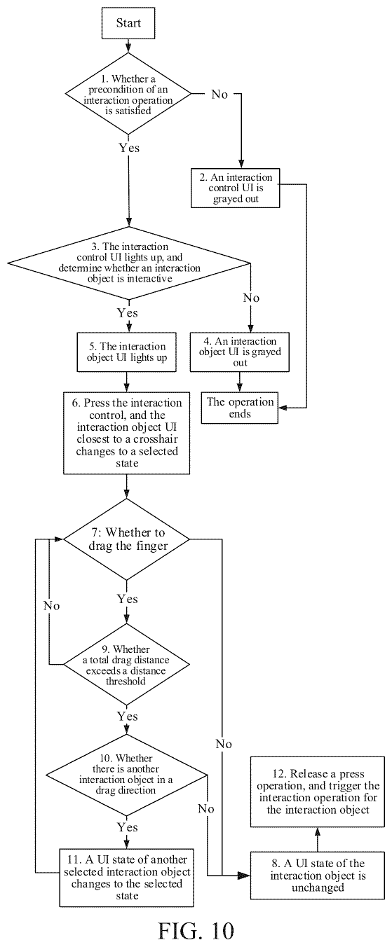

The interaction method in a virtual scene provided in the embodiments of this application continues to be described. FIG. 10 is a schematic flowchart of an interaction method in a virtual scene according to an embodiment of this application. The method includes the following operations:

Operation 1: First determine whether a player character satisfies a precondition for triggering the interaction operation, for example, whether the player character is in an available range of the interaction operation, whether a state of the player character is limited, or whether the player character satisfies an activation count. If the precondition for triggering the interaction operation is satisfied, perform operation 3; and if the precondition is not satisfied, perform operation 2.

Operation 2: The interaction control UI is grayed out. In this case, the selection operation cannot be entered, and the operation ends.

Operation 3: The interaction control UI lights up, and determine whether an interaction object displayed on a terminal screen is interactive, for example, whether the interaction object exists, whether the interaction object is in an interactive time window, or whether the interaction object satisfies another set interactive condition. If the interaction object is interactive, perform operation 5, and if the interaction object is not interactive, perform operation 4.

Operation 4: The corresponding interaction object UI in the screen is grayed out, and unavailable for a selection operation, indicating that the operation ends.

Operation 5: The corresponding interaction object UI in the screen lights up, and perform operation 6.

Operation 6: The player presses the interaction control. In this case, the interactive interaction object UI closest to the crosshair changes to the selected state.

Operation 7: Whether the player drags the finger. If the player drags the finger, perform operation 9; and if the player does not drag the finger, perform operation 8.

Operation 8: A UI state of the interaction object is unchanged, if the press operation is directly released, perform operation 12, and if the finger is dragged again, perform operation 9.

Operation 9: Determine whether a total drag distance exceeds a distance threshold, if the total drag distance exceeds the distance threshold, perform operation 10, and if the total drag distance does not exceed the distance threshold, go back to perform operation 7.

Operation 10: Determine whether there is another interaction object in a drag direction, if there is another interaction object in the drag direction, perform operation 11, and if there is no another interaction object in the drag direction, perform operation 8.

Operation 11: A UI state of another selected interaction object changes to the selected state, and change a UI state of a current interaction object to the unselected state. If the drag is continued, perform operation 9, and if the drag is stopped, perform operation 8.

Operation 12: Release the press operation, and trigger the interaction operation for the interaction object.

By applying the embodiments of this application, in the game scene in which the player selects the interaction object from the plurality of interaction objects and releases the corresponding interaction operation, the simplification of the selection of the interaction object and the trigger of the interaction operation for the interaction object improves the operation efficiency, enabling the player to quickly control the interaction object to release the corresponding interaction operation in an interaction process, thereby improving the experience of the game scene.

The following continues to describe an exemplary structure of the interaction apparatus 555 in a virtual scene provided in the embodiments of this application that is implemented as a software module. In some embodiments, as shown in FIG. 2, the software module in the interaction apparatus 555 in a virtual scene that is stored in the memory 550 may include: a display module 5551, configured to: display a plurality of interaction objects in a virtual scene, and display at least one interaction control, the plurality of interaction objects including a first interaction object, the at least one interaction control including a first interaction control, and each interaction control being associated with an interaction operation for an interaction object; a first control module 5552, configured to: control, in response to a press operation for the first interaction control, the first interaction control to be in a pressed state; and a second control module 5553, configured to: control, in response to a selection operation for the first interaction object that is triggered based on the first interaction control in the pressed state, the first interaction object to be in a selected state; and a third control module 5554, configured to: perform, in response to a release operation for the press operation, an interaction operation associated with the first interaction control for the first interaction object.

In some embodiments, the display module 5551 is further configured to: determine at least one target interaction operation performable for the plurality of interaction objects; and display an interaction control of the at least one target interaction operation, the interaction control and the target interaction operation being in a one-to-one correspondence.

In some embodiments, the display module 5551 is further configured to display, for each interaction object, interaction indication information of the interaction object, the interaction indication information being configured for indicating an interaction operation performable for the interaction object.

In some embodiments, the display module 5551 is further configured to perform the following processing for each interaction control: displaying the interaction control in an activated state by using a first control style when an activation condition of the interaction control is satisfied; or displaying the interaction control in an inactivated state by using a second control style when the activation condition of the interaction control is not satisfied.

In some embodiments, the display module 5551 is further configured to display a plurality of interaction objects under a first perspective in the virtual scene; and the first control module 5552 is further configured to: control the first perspective to be in a locked state after the first interaction control is controlled to be in the pressed state; and receive, in the locked state, the selection operation for the first interaction object that is triggered based on the first interaction control in the pressed state.

In some embodiments, the first control module 5552 is further configured to trigger the press operation for the first interaction control in at least one of the following manners: a press duration for the first interaction control reaching a press duration threshold; a press intensity for the first interaction control reaching a press intensity threshold; and a press area for the first interaction control reaching a press area threshold.

In some embodiments, the display module 5551 is further configured to: after the first interaction control is controlled to be in the pressed state, display a state exit control for the pressed state; and control, in response to a trigger operation for the state exit control, the first interaction control to exit the pressed state.

In some embodiments, the first control module 5552 is further configured to: receive a drag operation performed from a press action position of the press operation; and receive, when a drag end position of the drag operation is configured for indicating to select the first interaction object, the selection operation for the first interaction object that is triggered based on the first interaction control in the pressed state.

In some embodiments, the first control module 5552 is further configured to determine, when the drag end position is in a sensing region of the first interaction object, that the drag end position is configured for indicating to select the first interaction object.

In some embodiments, the first control module 5552 is further configured to: determine, when the drag end position is in a region at which a selection control of the first interaction object is located, that the drag end position is configured for indicating to select the first interaction object.

In some embodiments, the display module 5551 is further configured to display a selection wheel, the selection wheel being configured to display a selection control of each interaction object in a wheel form around the first interaction control; the first control module 5552 is further configured to receive the drag operation performed on the selection control of the first interaction object in the selection wheel from a press action position of the press operation; and the first control module 5552 is further configured to determine, when the drag end position is in the selection control of the first interaction object in the selection wheel, that the drag end position is configured for indicating to select the first interaction object.

In some embodiments, the display module 5551 is further configured to display an operation region of the drag operation; the first control module 5552 is further configured to receive, within the operation region, the drag operation performed from the press action position of the press operation; and the first control module 5552 is further configured to determine, when the drag end position is a target position within the operation region, that the drag end position is configured for indicating to select the first interaction object, where the target position corresponds to a position of the first interaction object.

In some embodiments, the display module 5551 is further configured to display a crosshair pattern corresponding to the drag operation, a crosshair position of the crosshair pattern being a position indicated by an action point of the drag operation in the virtual scene; and the first control module 5552 is further configured to determine, when the drag operation ends and the crosshair position of the crosshair pattern is located at a sensing region of the first interaction object, that the drag end position is configured for indicating to select the first interaction object.

In some embodiments, the virtual scene includes a target virtual object, the target virtual object has a virtual aiming item, and the display module 5551 is further configured to display a crosshair pattern of the virtual aiming item; the first control module 5552 is further configured to: after the first interaction control is controlled to be in the pressed state, determine a first distance between a position of each interaction object and a crosshair position of the crosshair pattern; and receive, when an interaction object corresponding to a smallest first distance is the first interaction object, the selection operation for the first interaction object that is triggered based on the first interaction control in the pressed state.

In some embodiments, the second control module 5553 is further configured to: after the first interaction object is controlled to be in the selected state, receive a move operation for the crosshair pattern in the pressed state; determine a second distance between the position of each interaction object and the crosshair position of the crosshair pattern when a movement distance of the crosshair pattern reaches a distance threshold; control the first interaction object to exit the selected state, and control the first interaction object to exit the selected state, and controlling a second interaction object corresponding to a smallest second distance to be in the selected state, the plurality of interaction objects including the second interaction object.

In some embodiments, the second control module 5553 is further configured to: after the first interaction object is controlled to be in the selected state, display the first interaction object by using a first object style; and display other interaction objects of the plurality of interaction objects except the first interaction object by using a second object style, the second object style being different from the first object style.

By applying the embodiments of this application, when the press operation for the first interaction control of the at least one interaction control is received, the first interaction control is controlled to be in the pressed state. In this case, the selection operation for the first interaction object of the plurality of interaction objects that is triggered based on the first interaction control may be received in the pressed state, to select the first interaction object. When the press operation is released, the interaction operation associated with the first interaction control is automatically performed for the first interaction object. In this way, the selection function of selecting the first interaction object from the plurality of interaction objects and the function of triggering the interaction operation for the first interaction object are integrated into one interaction control, which not only improves the utilization of device display resources, but also reducing human-computer interaction operations required to achieve interaction objectives, thereby improving the human-computer interaction efficiency and the utilization of device processing resources.

An embodiment of this application further provides a computer program product. The computer program product includes computer-executable instructions or a computer program The computer-executable instructions or the computer program is stored in a computer-readable storage medium. A processor of an electronic device reads the computer-executable instructions or the computer program from the computer-readable storage medium, and the processor executes the computer-executable instructions or the computer program, so that the electronic device performs the interaction method in a virtual scene provided in the embodiments of this application.

An embodiment of this application further provides a non-transitory computer-readable storage medium. The computer-readable storage medium stores computer-executable instructions or a computer program. When the computer-executable instructions or the computer program is executed by a processor, the processor is caused to perform the interaction method in a virtual scene provided in the embodiments of this application.

In some embodiments, the computer-readable storage medium may be a memory such as a RAM, a ROM, a flash memory, a magnetic surface memory, an optical disc, or a CD-ROM, or may be various devices including one or any combination of the memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

For example, the computer-executable instructions may, but do not necessarily correspond to a file in a file system, and may be stored as a part of a file that saves another program or data, for example, stored in one or more scripts in a hypertext markup language (HTML) file, stored in a single file dedicated to a program in discussion, or stored in a plurality of collaborative files (for example, files that store one or more modules, subprograms, or code parts).

For example, the computer-executable instructions may be deployed to be executed on one electronic device, or executed on a plurality of electronic devices located at one site, or executed on a plurality of electronic devices that are distributed in a plurality of sites and interconnected by a communication network.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules. Moreover, each module can be part of an overall module that includes the functionalities of the module. The foregoing descriptions described above are merely examples of the embodiments of this application, and this is not intended to limit the protection scope of this application. Any modification, equivalent replacement, and improvement made within the spirit and scope of this application shall fall within the protection scope of this application.

What is claimed is:

1. An interaction method in a virtual scene performed by an electronic device, the method comprising:
displaying a plurality of interaction objects and at least one interaction control in a virtual scene;
controlling, in response to a press operation for a first interaction control, the first interaction control to be in a pressed state;
controlling, in response to a selection operation for a first interaction object that is triggered based on the first interaction control in the pressed state, the first interaction object to be in a selected state; and
performing, in response to a release operation for the press operation, an interaction operation associated with the first interaction control for the first interaction object.

2. The method according to claim 1, wherein the displaying at least one interaction control comprises:
determining at least one target interaction operation performable for the plurality of interaction objects; and
displaying an interaction control of the at least one target interaction operation, the interaction control and the target interaction operation being in a one-to-one correspondence.

3. The method according to claim 1, wherein the method further comprises:
displaying, for each interaction object, interaction indication information of the interaction object, the interaction indication information indicating an interaction operation performable for the interaction object.

4. The method according to claim 1, wherein the displaying at least one interaction control comprises:
displaying the interaction control in an activated state by using a first control style when an activation condition of the interaction control is satisfied; and
displaying the interaction control in an inactivated state by using a second control style when the activation condition of the interaction control is not satisfied.

5. The method according to claim 1, wherein the displaying a plurality of interaction objects comprises:
displaying the plurality of interaction objects under a first perspective in the virtual scene;
after controlling the first interaction control to be in the pressed state:
controlling the first perspective to be in a locked state; and
receiving, in the locked state, the selection operation for the first interaction object that is triggered based on the first interaction control in the pressed state.

6. The method according to claim 1, wherein the method further comprises:
triggering the press operation for the first interaction control in at least one of the following manners:
a press duration for the first interaction control reaching a press duration threshold;
a press intensity for the first interaction control reaching a press intensity threshold; and
a press area for the first interaction control reaching a press area threshold.

7. The method according to claim 1, wherein the method further comprises:
after controlling the first interaction control to be in the pressed state:
displaying a state exit control of the pressed state; and
controlling, in response to a trigger operation for the state exit control, the first interaction control to exit the pressed state.

8. The method according to claim 1, wherein the method further comprises:
after controlling the first interaction control to be in the pressed state:
receiving a drag operation performed from a press action position of the press operation; and
receiving, when a drag end position of the drag operation is configured for indicating to select the first interaction object, the selection operation for the first interaction object that is triggered based on the first interaction control in the pressed state.

9. The method according to claim 1, wherein the virtual scene comprises a target virtual object, the target virtual object having a virtual aiming item, and the method further comprises:
displaying a crosshair pattern of the virtual aiming item;
after controlling the first interaction control to be in the pressed state:
determining a first distance between a position of each interaction object and the crosshair position of the crosshair pattern; and
receiving, when an interaction object corresponding to a smallest first distance is the first interaction object, the selection operation for the first interaction object that is triggered based on the first interaction control in the pressed state.

10. The method according to claim 1, wherein the method further comprises:
after controlling the first interaction object to be in the selected state:
displaying the first interaction object by using a first object style; and
displaying other interaction objects of the plurality of interaction objects except the first interaction object by using a second object style, the second object style being different from the first object style.

11. An electronic device, comprising:
a memory, configured to store computer-executable instructions; and
a processor, when executing the computer-executable instructions stored in the memory, configured to implement an interaction method in a virtual scene including:
displaying a plurality of interaction objects and at least one interaction control in a virtual scene;
controlling, in response to a press operation for a first interaction control, the first interaction control to be in a pressed state;
controlling, in response to a selection operation for a first interaction object that is triggered based on the first interaction control in the pressed state, the first interaction object to be in a selected state; and
performing, in response to a release operation for the press operation, an interaction operation associated with the first interaction control for the first interaction object.

12. The electronic device according to claim 11, wherein the displaying at least one interaction control comprises:
determining at least one target interaction operation performable for the plurality of interaction objects; and
displaying an interaction control of the at least one target interaction operation, the interaction control and the target interaction operation being in a one-to-one correspondence.

13. The electronic device according to claim 11, wherein the method further comprises:
displaying, for each interaction object, interaction indication information of the interaction object, the interaction indication information indicating an interaction operation performable for the interaction object.

14. The electronic device according to claim 11, wherein the displaying at least one interaction control comprises:
displaying the interaction control in an activated state by using a first control style when an activation condition of the interaction control is satisfied; and
displaying the interaction control in an inactivated state by using a second control style when the activation condition of the interaction control is not satisfied.

15. The electronic device according to claim 11, wherein the displaying a plurality of interaction objects comprises:
displaying the plurality of interaction objects under a first perspective in the virtual scene;
after controlling the first interaction control to be in the pressed state:
controlling the first perspective to be in a locked state; and
receiving, in the locked state, the selection operation for the first interaction object that is triggered based on the first interaction control in the pressed state.

16. The electronic device according to claim 11, wherein the method further comprises:
triggering the press operation for the first interaction control in at least one of the following manners:
a press duration for the first interaction control reaching a press duration threshold;
a press intensity for the first interaction control reaching a press intensity threshold; and
a press area for the first interaction control reaching a press area threshold.

17. The electronic device according to claim 11, wherein the method further comprises:
after controlling the first interaction control to be in the pressed state:
receiving a drag operation performed from a press action position of the press operation; and
receiving, when a drag end position of the drag operation is configured for indicating to select the first interaction object, the selection operation for the first interaction object that is triggered based on the first interaction control in the pressed state.

18. The electronic device according to claim 11, wherein the virtual scene comprises a target virtual object, the target virtual object having a virtual aiming item, and the method further comprises:
displaying a crosshair pattern of the virtual aiming item;
after controlling the first interaction control to be in the pressed state:
determining a first distance between a position of each interaction object and the crosshair position of the crosshair pattern; and
receiving, when an interaction object corresponding to a smallest first distance is the first interaction object, the selection operation for the first interaction object that is triggered based on the first interaction control in the pressed state.

19. The electronic device according to claim 11, wherein the method further comprises:
after controlling the first interaction object to be in the selected state:
displaying the first interaction object by using a first object style; and
displaying other interaction objects of the plurality of interaction objects except the first interaction object by using a second object style, the second object style being different from the first object style.

20. A non-transitory computer-readable storage medium, having computer-executable instructions stored therein, the computer-executable instructions, when executed by a processor of an electronic device, causing the electronic device to implement an interaction method in a virtual scene including:
displaying a plurality of interaction objects and at least one interaction control in a virtual scene;
controlling, in response to a press operation for a first interaction control, the first interaction control to be in a pressed state;
controlling, in response to a selection operation for a first interaction object that is triggered based on the first interaction control in the pressed state, the first interaction object to be in a selected state; and
performing, in response to a release operation for the press operation, an interaction operation associated with the first interaction control for the first interaction object.
